(19) United States
(12) Patent Application Publication
(10) Pub. No.: US 2006/0288033 A1
(43) Pub. Date: Dec. 21, 2006

(54) System for pre-caching reports of streaming data

(75) Inventor: Gilad Raz, Mevaseret Tzion (IL)

Correspondence Address: DANIEL J SWIRSKY, 55 REUVEN ST., BEIT SHEMESH, 99544, IL

(73) Assignee: Digital Fuel Technologies, Inc.

(21) Appl. No.: 11/153,493

(22) Filed: Jun. 16, 2005

(51) Int. Cl. G06F 7/00

(52) U.S. Cl. 707/102

(57) ABSTRACT

A system for pre-cached report generation including a report scheduler operative to create and schedule a report request for execution at a predetermined time, a service engine operative to determine in accordance with a predefined operation criterion whether the report may be generated responsive to a request by the report scheduler to generate the report at the predetermined time, and a report generator operative to generate the report responsive to a request by the report scheduler to generate the report after the service engine determines that the report may be generated.

### FIELD OF THE INVENTION

The present invention relates to data processing in general, and more particularly to the pre-caching of reports of streaming data.

### BACKGROUND OF THE INVENTION

In data processing, reports that are accessed repeatedly may be “cached” or stored after their generation for subsequent retrieval. Unfortunately, many reports are often accessed only once or twice, yet need to be generated repeatedly. While traditional caching techniques perform adequately for data that varies little over time and is accessed often, caching may waste storage resources where reports are only accessed once. Furthermore, processing large quantities of data that are often required in preparing a report may be computationally expensive and may take a long time.

One popular method for minimizing the computational expense is to pre-cache reports, where the report is prepared prior to the actual request for it, preferably during off hours. Unfortunately, the accumulation of the data may occur over a relatively long time, such as with streaming data. It would be advantageous not to wait for all the data to arrive prior to preparing the report.

### SUMMARY OF THE INVENTION

In one aspect of the present invention a system is provided for pre-cached report generation including a report scheduler operative to create and schedule a report request for execution at a predetermined time, a service engine operative to determine in accordance with a predefined operation criterion whether the report may be generated responsive to a request by the report scheduler to generate the report at the predetermined time, and a report generator operative to generate the report responsive to a request by the report scheduler to generate the report after the service engine determines that the report may be generated.

In another aspect of the present invention the report scheduler is operative to schedule the report request in response to a request from a client to do so.

In another aspect of the present invention the report is adapted for use with streaming data accumulated over a time period.

In another aspect of the present invention the report scheduler is operative to request that the report generator execute an incremental report request at a predetermined time based on pre-defined heuristics.

In another aspect of the present invention the report request includes a report descriptor describing the report.

In another aspect of the present invention the predefined operation criterion is whether data required for the report generation is available.

In another aspect of the present invention the predefined operation criterion is whether sufficient processing resources are available for the report generation.

In another aspect of the present invention the report scheduler is operative to prioritize the report request among a plurality of other report requests according to a prioritization scheme.

In another aspect of the present invention the report scheduler is operative to prioritize the report requests such that low-priority reports are generated during non-peak hours.

In another aspect of the present invention the report generator is operative to pre-cache the generated report along with a report identifier identifying the report.

In another aspect of the present invention the report scheduler is operative to retrieve the pre-cached report by searching for the report identifier.

In another aspect of the present invention the service engine is operative to notify the report scheduler of a change to data from which the report is to be generated.

In another aspect of the present invention the report scheduler is operative to periodically poll a database containing the data to detect the change.

In another aspect of the present invention the report scheduler is operative to request that the report generator execute an incremental report request to process the change.

In another aspect of the present invention the report scheduler is operative to request that the report generator execute an incremental report request in response to a query for the report.

In another aspect of the present invention the report scheduler is operative to determine what aspects of the report would be affected by the change, and create the incremental report to effect the change within the report.

In another aspect of the present invention a method is provided for pre-cached report generation including creating and scheduling a report request for execution at a predetermined time, determining in accordance with a predefined operation criterion whether the report may be generated responsive to a request to generate the report at the predetermined time, and generating the report responsive to a request to generate the report after the determining step determines that the report may be generated.

In another aspect of the present invention the method further includes executing an incremental report request to process a change to data from which the report is to be generated.

In another aspect of the present invention the method further includes determining what aspects of the report would be affected by the change, and creating the incremental report to effect the change within the report.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a system for generating and pre-caching reports of streaming data, constructed and operative in accordance with a preferred embodiment of the present invention;

FIG. 1B is a simplified flowchart illustration of a method for generating and pre-caching reports of streaming data, operative in accordance with a preferred embodiment of the present invention;

FIG. 2A is a simplified flowchart illustration of a method for incremental pre-caching reports of streaming data, operative in accordance with a preferred embodiment of the present invention; and

FIGS. 2B through 2C, taken together, is a simplified pictorial illustration of a sample incremental report constructed from changing data, operative in accordance with a preferred embodiment of the present invention.

### DETAILED DESCRIPTION OF PREFERRED EMBODIMENTS

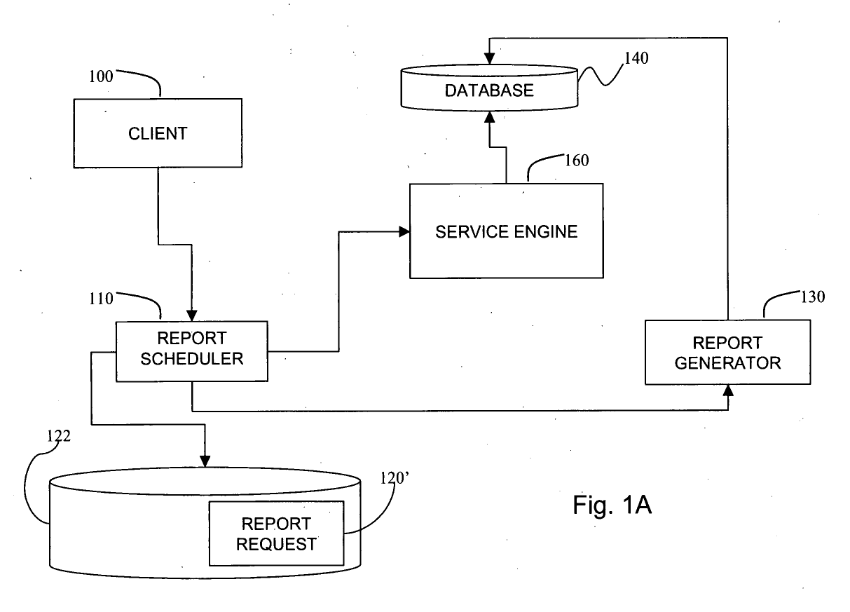

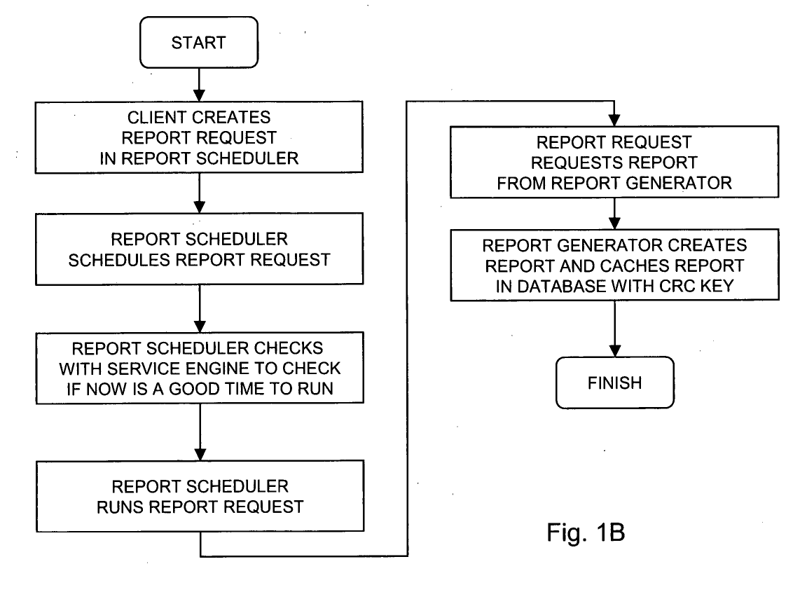

Reference is now made to FIG. 1A, which is a simplified pictorial illustration of a system for generating and pre-caching reports of streaming data, constructed and operative in accordance with a preferred embodiment of the present invention, and to FIG. 1B, which is a simplified flowchart illustration of a method for generating and pre-caching reports of streaming data, operative in accordance with a preferred embodiment of the present invention. A client 100 preferably requests the scheduling of the generation of a report drawing from data, such as streaming data that has been processed and accumulated over time, stored in a database 140. Methods for processing and accumulating data over time are described in Applicant/Assignee's U.S. patent application Ser. No. 11/027,673, filed Jan. 3, 2005, and entitled “System for Parameterized Processing of Streaming Data”, the disclosure of which is incorporated herein by reference. Client 100 preferably communicates the request for scheduling the report to a report scheduler 110 that creates and schedules a report request 120 in a scheduled report database 122 for execution at a later date.

Each report request 120 defines a specific request for a report. A report request preferably includes a report descriptor, such as a header, which describes the meta-data of the report. For example, the following header:

| Start | Data | Filters | Context |
|---|---|---|---|
| 10:00:15a | Ping | Region Filter | Business Unit 1 |

describes a report that is requested regarding data collected from a Ping data stream starting at 10:00:15 am, where the data is filtered with a Region Filter, which removes all data not from a particular region, and is available to a particular business unit. At the appointed time indicated by scheduled report request 120, report scheduler 110 checks with a service engine 160 to determine whether the scheduled report may be generated. Engine 160 preferably makes this determination based on a predefined operation criterion, such as whether the data required for report generation is available, and/or whether sufficient processing resources are available. Engine 160 may respond affirmatively, or may decide to defer the generation of the report for a period of time, such as where engine 160 determines that the Ping data from 10:00:15 required for the report has yet to arrive or where engine 160 is busy performing other computationally intensive tasks. Where engine 160 indicates that the report may be generated, scheduler 110 may prioritize report request 120 along with previous report requests in database 122 according to any prioritization scheme, such as where low-priority reports are generated during non-peak hours and high-priority reports are generated as soon as possible.

When report scheduler 110 executes report request 120, scheduler 110 instructs a report generator 130 to generate the report. Report generator 130 typically constructs and applies a set of queries on database 140 to fulfill the report request and generates the report. Report generator 130 preferably pre-caches the report, placing the report in database 140 together with an identifier identifying the report that will be used for future access. The report identifier may be a key that is generated as a hash of the report descriptor, such as by generating a 64 bit CRC of the report header.

Client 100 may instruct report scheduler 110 to retrieve a report. Report scheduler 110 may then create a report request 120 and query report generator 130 to determine if a report with a similar report request 120 has been previously cached. Report generator 130 preferably constructs the key as described above and searches database 140 for a cached version of the report with the same key. If report generator 130 finds the cached report in database 140, report scheduler 110 may retrieve the cached report, via report generator 130, and thus avoid scheduling the report for generation.

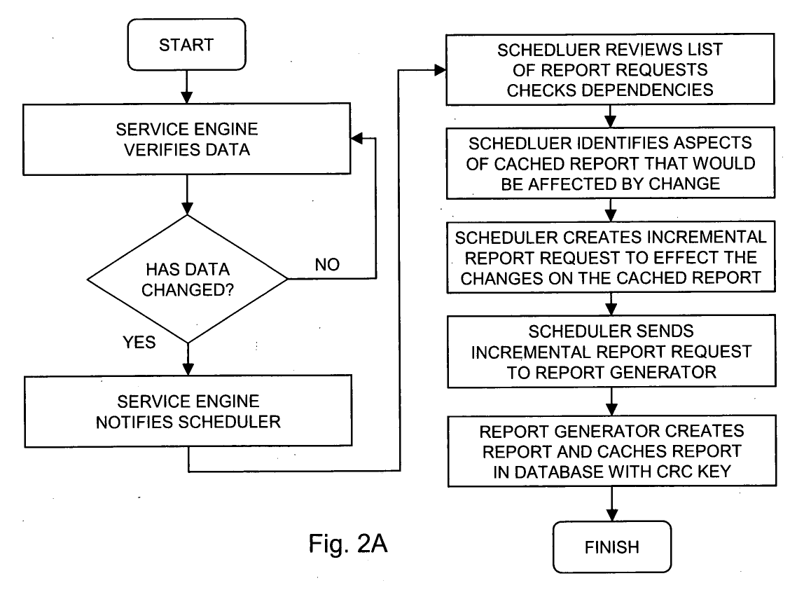

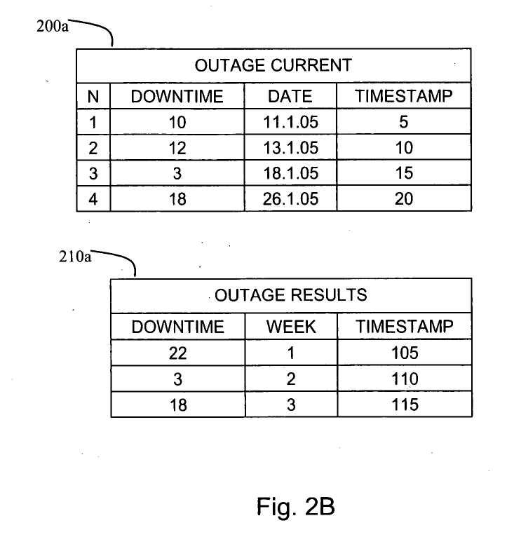

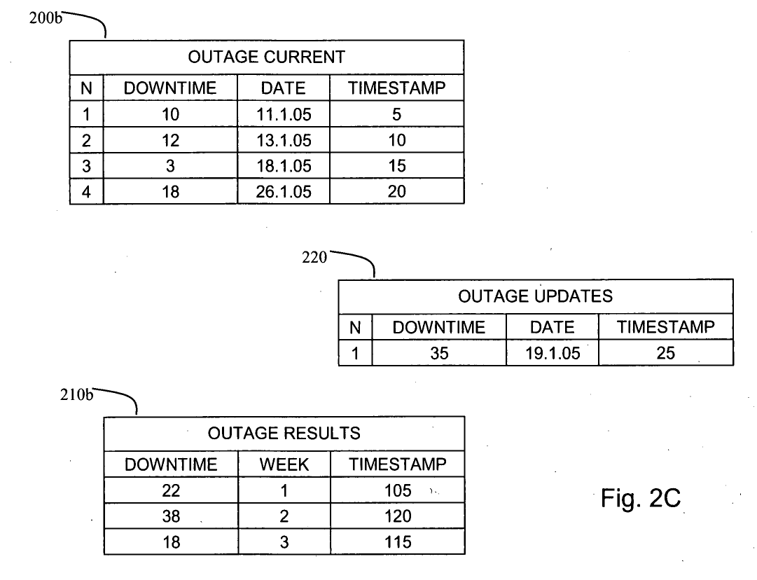

Reference is now made to FIG. 2A, which is a simplified flowchart illustration of a method for incremental pre-caching reports of streaming data, operative in accordance with a preferred embodiment of the present invention, and FIGS. 2B and 2C, which are simplified pictorial illustrations of a sample incremental report constructed from changing data, operative in accordance with a preferred embodiment of the present invention. In the method of FIG. 2A incremental report requests are processed, where incremental report requests are requests to modify reports generated previously in response to scheduled report requests 120. Scheduler 110, shown in FIG. 1A, preferably reviews a list of scheduled report requests 120 and requests that report generator 130 execute an incremental report based on any report request 120 at a predetermined time based on pre-defined heuristics. These heuristics may, for example, be defined to maximize off-hour processing, such as to perform report generation between the hours of 2am to 4am every night.

As additional streaming data are accumulated in database 140, service engine 160 preferably notifies scheduler 110 of any changes, such as modifications, additions or deletions, to data in database 140 that are relevant to the requested report. Alternatively, scheduler 110 may periodically poll database 140 to detect changes to such data. Scheduler 110 may then choose to create an incremental report request to determine what aspects of the previously cached report, which was generated based on the previously executed report request, would be affected by the changes. Scheduler 110 may then create the incremental report request to effects the changes on the previously cached report. The determination of which aspects would be affected by the changes is preferably achieved by using techniques described in applicant/assignee's co-pending US Patent Application entitled “A method for aggregate operations on streaming data,” filed Jun. 16, 2005, the disclosure of which is incorporated herein by reference.

The next time client 100 requests a report, report scheduler 110 preferably queries database 140 and may retrieve the pre-cached report from database 140 or may run an incremental change report necessary to update the report.

In the example shown in FIG. 2B, client 100 requests a report of the cost incurred due to server outages aggregated per week. Each server outage is recorded, such as by using techniques described in applicant/assignee's co-pending US Patent Application entitled “A system for acquisition, representation and storage of streaming data,” filed Jun. 16, 2005, the disclosure of which is incorporated herein by reference, and made available in database 140 to service engine 160 for processing of current outage information stored in a table 200a. The columns in current outage table 200a describe an identifier of a server, N, the downtime in minutes of the server, the date of the occurrence of the downtime and a timestamp indicating when the entry was inserted into the table.

Service engine 160 processes the data stored in table 200a, such as in accordance with a predefined server outage process and stores the results in an outage results table 210a in database 140. For example, the server outage process may take the following form:
1. Aggregate server outage data from the data source by week.
2. Evaluate the cost of availability per week based on the aggregated information.
   In the first step, the server outage data is grouped by calendar weeks. All entries in database 140 regarding the outages that correspond to week #1 are grouped and summarized in a single row in outage results table 210a. Similarly, the entries in database 140 that regard the outages that correspond to week #2 and week #3 are stored in outage results in their respective rows. The columns of outage results describe the downtime of the servers during the enumerated week and a timestamp indicating when the entry was placed in the table outage results.

In the second step of the server outage process, the cost of the outages are evaluated and if there were outages that lasted more than twenty minutes in a single week their expected cost is calculated. For example, client 100 may specify that a week with twenty minutes of outages costs the company $1,000, and a week with more than thirty minutes outages costs the company $5,000.

Finally, report generator compiles and stores a report as described above, which includes the information available in outage results 210a.

In the example depicted in FIG. 2C, a new outage event entry is recorded at a later time, shown in outage updates 220. Service engine 160 process the new entry with the server outage process and incorporates the results in outage results 210b. Service engine 160 then notifies report scheduler 110 that a change has occurred in the data in database 140. Scheduler 110 preferably scans outage updates 220 and determines that the change to the data only effects results in week #2. Scheduler 110 preferably creates and schedules a new report request 120 for execution at a later date that only process information relevant to week #2. Thus, if it would take report generator 130 three minutes to reprocess the entire report, one minute for each week, with the current invention report generator need only reprocess one week, week #2, saving two thirds of the processing time.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention. Various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

What is claimed is:

1. A system for pre-cached report generation comprising:
a report scheduler operative to create and schedule a report request for execution at a predetermined time;
a service engine operative to determine in accordance with a predefined operation criterion whether said report may be generated responsive to a request by said report scheduler to generate said report at said predetermined time; and
a report generator operative to generate said report responsive to a request by said report scheduler to generate said report after said service engine determines that said report may be generated.

2. A system according to claim 1 wherein said report scheduler is operative to schedule said report request in response to a request from a client to do so.

3. A system according to claim 1 wherein said report is adapted for use with streaming data accumulated over a time period.

4. A system according to claim 1 wherein said report scheduler is operative to request that said report generator execute an incremental report request at a predetermined time based on pre-defined heuristics.

5. A system according to claim 1 wherein said report request includes a report descriptor describing said report.

6. A system according to claim 1 wherein said predefined operation criterion is whether data required for said report generation is available.

7. A system according to claim 1 wherein said predefined operation criterion is whether sufficient processing resources are available for said report generation.

8. A system according to claim 1 wherein said report scheduler is operative to prioritize said report request among a plurality of other report requests according to a prioritization scheme.

9. A system according to claim 1 wherein said report scheduler is operative to prioritize said report requests such that low-priority reports are generated during non-peak hours.

10. A system according to claim 1 wherein said report generator is operative to pre-cache said generated report along with a report identifier identifying said report.

11. A system according to claim 11 wherein said report scheduler is operative to retrieve said pre-cached report by searching for said report identifier.

12. A system according to claim 1 wherein said service engine is operative to notify said report scheduler of a change to data from which said report is to be generated.

13. A system according to claim 12 wherein said report scheduler is operative to periodically poll a database containing said data to detect said change.

14. A system according to claim 12 wherein said report scheduler is operative to request that said report generator execute an incremental report request to process said change.

15. A system according to claim 1 wherein said report scheduler is operative to request that said report generator execute an incremental report request in response to a query for said report.

16. A system according to claim 14 wherein said report scheduler is operative to:
determine what aspects of said report would be affected by said change; and
create said incremental report to effect said change within said report.

17. A method for pre-cached report generation comprising:
creating and scheduling a report request for execution at a predetermined time;
determining in accordance with a predefined operation criterion whether said report may be generated responsive to a request to generate said report at said predetermined time; and
generating said report responsive to a request to generate said report after said determining step determines that said report may be generated.

18. A method according to claim 17 and further comprising executing an incremental report request to process a change to data from which said report is to be generated.

19. A method according to claim 18 and further comprising:
determining what aspects of said report would be affected by said change; and
creating said incremental report to effect said change within said report.
